(19) United States
(12) Patent Application Publication
(10) Pub. No.: US 2024/0359663 A1
(43) Pub. Date: Oct. 31, 2024

(54) ASSEMBLIES FOR CLEANING LARGE, VERTICAL, PLANAR SURFACE AREAS AND METHODS OF USE

(71) Applicant: Pamela Lee, Idaho Falls, ID (US)

(72) Inventor: Pamela Lee, Idaho Falls, ID (US)

(21) Appl. No.: 18/306,905

(22) Filed: Apr. 25, 2023

(51) Int. Cl. B60S 3/04; B25G 1/04; B32B 5/06; B32B 7/022

(52) U.S. Cl. CPC B60S 3/045; B25G 1/04; B32B 5/073; B32B 7/022; B32B 2262/062; B32B 2307/546; B32B 2307/726; B32B 2432/00

(57) ABSTRACT

A cleaning assembly includes a head component and an attachment component selectively attachable to a panel of the head component. A joint sub-assembly is supported by a rear surface of the panel. A handle component is selectively attachable to the joint sub-assembly. The joint sub-assembly defines at least two axes of rotation for moving the head component relative to the handle component. The at least two axes of rotation include a first axis and a second axis that is perpendicular to the first axis. The cleaning assembly may be used to clean a target surface of a vehicle, such as a substantially planar and substantially vertical target surface. The handle component may be manipulated to move the head component along the target surface while maintaining direct contact between the target surface and substantially a whole of a cleaning surface of the attachment component.

### TECHNICAL FIELD

The present disclosure relates generally to assemblies and methods for cleaning (e.g., washing, drying) relatively large, vertical, planar surfaces. More particularly, the present disclosure relates to assemblies and methods of using such assemblies for cleaning surfaces (e.g., sides) of large structures, such as motorhomes, recreational vehicles (RVs), and trailers.

### BACKGROUND

Large vehicles (e.g., recreational vehicles (RVs), motorhomes, semi-trailer trucks (also known as “semitrucks” and “semis”)) and other large articles (e.g., manufactured homes, trailers) often have surfaces that are relatively large in area, generally-planar, and substantially-vertical relative to the ground. Portions of these surfaces may have elevations or areas that are generally difficult to reach (e.g., out of general “arms' reach”). Often, these large, vertical, planar surface areas are several feet (e.g., several meters) in height and/or width. The relatively-large dimensions of these vehicles and other large articles can present cleaning (e.g., washing, drying) challenges.

Efforts have been made to provide systems configured for applying detergents and cleaning fluids (e.g., water) to remove dirt and debris from large vehicles. However, many commercial systems for washing large vehicles tend to lack sufficient means for reaching all areas of the target surfaces and/or for targeting particular areas for additional scrubbing and/or for drying. Accordingly, there continues to be a need for effective and efficient means for cleaning (e.g., washing, drying) relatively large, vertical, planar surface areas of large vehicles and other large articles.

### BRIEF SUMMARY

Various embodiments of the disclosure relate to assemblies and their use in the context of cleaning (e.g., washing, drying) relatively large, planar, vertical surface areas, such as the sides of relatively large vehicles.

According to some embodiments, a cleaning assembly comprises a head component and an attachment component selectively attachable to a panel of the head component. A joint sub-assembly is supported by a rear surface of the panel. A handle component is selectively attachable to the joint sub-assembly. The joint sub-assembly defines at least two axes of rotation for moving the head component relative to the handle component. The at least two axes of rotation include a first axis and a second axis that is perpendicular to the first axis.

Also, according to some embodiments, the aforementioned cleaning assembly may be used to clean a target surface of a vehicle. The method comprises removably attaching the attachment component to the front surface of the panel of the head component. The handle component is removably attached to the joint sub-assembly. A cleaning surface of the attachment component is applied against a target surface of a vehicle. The target surface is substantially planar and substantially vertical. The handle component is manipulated to move the head component along the target surface while maintaining direct contact between the target surface and substantially a whole of the cleaning surface of the attachment component.

### BRIEF DESCRIPTION OF THE DRAWINGS

FIG. 1 is an elevational, rear, exploded illustration of a cleaning assembly, according to embodiments of the disclosure.

FIG. 2 is an elevational, front illustration of an attachment component of the cleaning assembly of FIG. 1, according to embodiments of the disclosure.

FIG. 3 is a cross-sectional and isometric view of the attachment component of FIG. 2, taken along section line A-A of FIG. 2, according to embodiments of the disclosure.

FIG. 4 is an elevational, rear illustration of the attachment component of FIG. 2.

FIG. 5 is an elevational, partially-exploded illustration of an upper portion of the cleaning assembly of FIG. 1, illustrating a front view of the handle and head components (and/or illustrating a rear view of the handle and head components with the head component inverted) and illustrating a rear view of the attachment component (and/or illustrating a front view of the attachment component inverted).

FIG. 6 is an elevational, rear illustration of the upper portion of the cleaning assembly of FIG. 1, wherein the cleaning assembly is in a fully-assembled state and in a horizontal configuration.

FIG. 7 is an elevational, rear, partially-exploded illustration of the upper portion of the cleaning assembly of FIG. 1, wherein the cleaning assembly is in a partially-assembled state and in the horizontal configuration.

FIG. 8 is an elevational, side illustration of the upper portion of the cleaning assembly of FIG. 1, wherein the cleaning assembly is in a fully-assembled state and in a vertical configuration.

FIG. 9 is an elevational, enlarged, rear illustration of a joint sub-assembly of the cleaning assembly of FIG. 1, according to embodiments of the disclosure, wherein the cleaning assembly is in the horizontal configuration and a locking mechanism is engaged.

FIG. 10 is an elevational, enlarged, right-side illustration of the joint sub-assembly of the cleaning assembly of FIG. 9, according to embodiments of the disclosure, wherein the cleaning assembly is in the horizontal configuration and the locking mechanism is disengaged.

FIG. 11 is an elevational, right-side and/or left-side illustration of the handle component of the cleaning assembly of FIG. 1.

### DETAILED DESCRIPTION

Disclosed is a cleaning assembly and methods of use for cleaning (e.g., washing, drying) articles (e.g., devices, vehicles, structures) having relatively large surface areas, such as for drying the vertical sides of recreational vehicles (RVs). An attachment component is selectively attachable and detachable to and from a head component. At least a front surface of the attachment component may be formed of a relatively absorbent material, which may extend beyond the periphery of the head component when the attachment component is attached to the head component. A handle component may be selectively attachable and detachable to and from the head component via a joint sub-assembly. The handle component may be adjustable in length, such as with a telescoping shaft. The joint sub-assembly may be configured to permit selective rotation of the handle component relative to the head (and attachment) component, about one of two perpendicular axes. The joint sub-assembly may also be configured to facilitate transitioning the cleaning assembly from a “horizontal configuration” (wherein a lateral centerline of the head component is substantially parallel to the handle component) to a “vertical configuration” (wherein a longitudinal centerline of the head component is substantially parallel to the handle component). For use in cleaning, the attachment component is removably attached to the head component, such as by a hook-and-loop engagement, and the handle component is attached to the joint sub-assembly. The attachment component may be structured to permit a cleaning surface of the cleaning assembly to remain substantially planar and against the target surface during use, so that a maximum amount of the cleaning surface may be applied to the target surface.

The following description provides specific details, such as method acts and conditions and structural features and characteristics, such as stages, components, features, articles, assemblies, materials, compositions, properties, and/or other characteristics, in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below may not describe all assembly components, features, articles, materials, compositions, properties, and/or other characteristics of a complete assembly or article, nor all method stages, conditions, techniques, and/or other parameters of a complete method. Only those components, features, articles, materials, compositions, properties, characteristics, stages, conditions, techniques, and/or parameters necessary to understand the embodiments of the disclosure are described in detail below. Additional features and/or acts may be included and/or performed, respectively, according to conventional features and/or techniques, respectively. Also, the illustrated drawings accompanying the present application are for illustrative purposes only, and are thus not necessarily drawn to scale.

The accompanying drawings are not necessarily meant to be actual views of any particular assembly, component, feature, structure, material, stage, etc. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, a region illustrated or described as round may include some rough and/or linear features, and a region illustrated or described as planar or flat may include some protruding or recessed features and/or moderate curvature. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

Moreover, while the text and accompanying drawings may reference particular features and/or method acts, it is to be understood that the disclosure includes all possible combinations and order of such particular features and/or method acts. For example, where a particular feature or act is disclosed in the context of a particular embodiment or a particular claim, that feature or act may also be incorporated, to the extent possible, in combination with and/or in the context of other particular aspects and embodiments described herein.

As used herein, the term “target surface,” means and refers to a surface that is to be cleaned or that is being cleaned using the cleaning assembly. The “target surface” may be relatively large (e.g., with a surface area of at least 3 ft. (0.9 m)×3 ft. (0.9 m)), substantially planar, and—at least in some embodiments—substantially vertical relative to the ground.

As used herein, the term “length,” means and refers to an edge-to-edge dimension measured along a longitudinal centerline of a concerned article.

As used herein, the term “width,” means and refers to an edge-to-edge dimension measured along a lateral centerline of a concerned article.

Herein, when referring to X-axis, Y-axis, and Z-axis relative directions and motions, these directions and motions use, as a reference, a vertical handle component of the cleaning assembly, wherein a distal end of the handle component is elevationally above a proximal end of the handle component and the distal and proximal ends are aligned along the Z-axis, wherein front and rear sides of the handle component are aligned along the Y-axis, and left and right sides of the handle component are aligned along the X-axis.

As used herein, relative terms “first,” “second,” etc., are used for clarity and convenience in understanding the disclosure and accompanying drawings and do not connote or depend on any specific preference, orientation, or order, except where the context clearly indicates otherwise.

As used herein, the terms “front,” “rear,” “right,” and “left,” are spatially relative terms used to describe one element's relationship to another as illustrated in the figures, using—as a reference point—the front, rear, right-hand, and left-hand sides of a user of the cleaning assembly to clean a surface area of, e.g., a vehicle. Therefore, a “front” surface of a component of the assembly would be a surface facing the surface area being cleaned, while a “rear” surface of the component would be a surface facing the user of the cleaning assembly during use against the surface area being cleaned. Also, a “right” side of the component would be on the right-hand side of the user while the cleaning assembly is in use against a surface area being cleaned, and a “left” side of the component would be on the left-hand side of the user while the cleaning assembly is in use against the surface area being cleaned.

As used herein, the terms “comprising,” “including,” “having,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may”—when used with respect to a system, a device, an article, a component, a material, and/or other physical object or feature thereof, or to a method, an act, and/or other aspect thereof—indicates that such is contemplated for use in implementation of an embodiment of the disclosure, and such term is used in preference to the more restrictive term “is” so as to avoid any implication that other compatible systems, devices, articles, components, materials, and/or other physical objects or features thereof, or methods, acts, and/or other aspects thereof, usable in combination therewith, should or must be excluded.

As used herein, the terms “for example” and “e.g.,” indicate that the related description is explanatory and, though the scope of the disclosure is intended to encompass the examples and legal equivalents, the use of such terms is not intended to limit the scope of an embodiment or this disclosure to that which is specified, such as the specified components, acts, features, functions, or the like.

As used herein, the term “configured” refers to a parameter, condition, characteristic, or other feature that facilitates, in a predetermined way, a described purpose, function, or other descriptor.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” or “approximately,” when used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0% to 102.0% of the numerical value, such as within a range of from 95.0% to 105.0% of the numerical value, within a range of from 97.5% to 104.5% of the numerical value, within a range of from 99.0% to 101.0% of the numerical value, within a range of from 99.5% to 100.5% of the numerical value, or within a range of from 99.9% to 100.1% of the numerical value.

As used herein, the terms “on” or “over,” when referring to an element as being “on” or “over” another element, are spatially relative terms that mean and include the element being directly on top of, adjacent to (e.g., laterally adjacent to, horizontally adjacent to, longitudinally adjacent to, vertically adjacent to), underneath, or in direct contact with the other element. It also includes the element being indirectly on top of, adjacent to (e.g., laterally adjacent to, horizontally adjacent to, longitudinally adjacent to, vertically adjacent to), underneath, or near the other element, with other elements present therebetween. In contrast, when an element is referred to as being “directly on” or “directly adjacent to” another element, there are no intervening elements present.

As used herein, other spatially relative terms, such as “below,” “lower,” “bottom,” “above,” “upper,” “top,” and the like, may be used for ease of description to describe one element's or feature's relationship to another element(s) or feature(s) as illustrated in the figures. Unless otherwise specified, any spatially relative terms used in this disclosure are intended to encompass different orientations of the materials in addition to the orientation as depicted in the figures. For example, if materials in the figures are inverted, elements described as “below” or “under” or “on bottom of” other elements or features would then be oriented “above” or “on top of” the other elements or features. Thus, the term “below” may encompass both an orientation of above and below, depending on the context in which the term is used, which will be evident to one of ordinary skill in the art. The materials may be otherwise oriented (rotated ninety degrees, inverted, etc.) and the spatially relative descriptors used herein interpreted accordingly.

As used herein, the singular forms “a,” “an,” and “the” are intended to include the plural forms as well, unless the context clearly indicates otherwise.

As used herein, an “(s)” at the end of a term means and includes the singular form of the term and/or the plural form of the term, unless the context clearly indicates otherwise.

As used herein, the term “and/or” includes any and all combinations of one or more of the associated listed items.

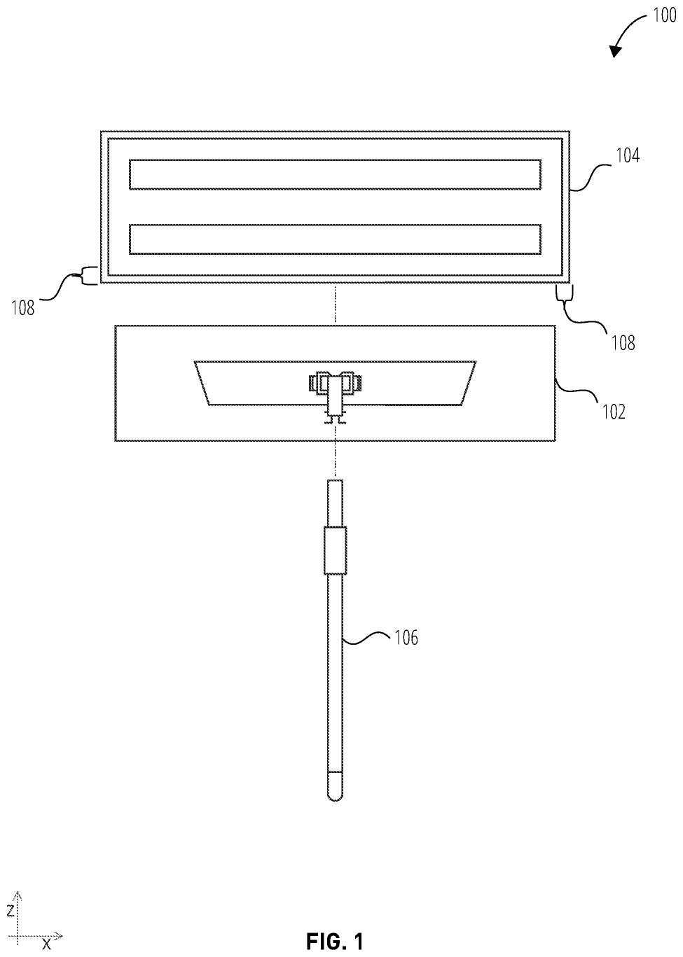

FIG. 1 illustrates an exploded, rear-side view of a cleaning assembly 100. The cleaning assembly 100 generally includes a head component 102, an attachment component 104 configured to removably connect to the head component 102, and a handle component 106 configured to removably connect to the head component 102. The attachment component 104 may be selectively attachable to and detachable from the head component 102, and the head component 102 may be selectively attachable to and detachable from the handle component 106. When attached to the head component 102, the attachment component 104 may define a relatively large cleaning (e.g., washing, drying) surface configured for cleaning relatively large, planar surface(s) of another structure (e.g., a recreation vehicle). During cleaning, the cleaning assembly 100 may be manipulated through a user's movement of the handle component 106.

Accordingly, the cleaning assembly 100 may be utilized in the context of cleaning and/or drying relatively large surface areas. As a non-limiting example, the cleaning assembly 100 may be configured and operated to clean and/or dry relatively large, at least partially (e.g., substantially) planar surfaces, which may be substantially vertical, such as the sides of recreational vehicles or other structures. However, the use of the cleaning assembly 100 is not limited to the cleaning and/or drying context, and it is not limited to use with recreational vehicles. In the cleaning and/or drying context, the cleaning assembly 100 may function as a drying tool. Therefore, the cleaning assembly 100 may be used to remove fluid from the structure surface(s) being cleaned. Such fluid may include water, soap, and/or any other cleaning products used while washing the structure (e.g., vehicle). The fluid may also or alternatively include rain or other forms of precipitation. After cleaning, the attachment component 104 may be removed from the head component 102 and other components of the cleaning assembly 100 for cleaning of the attachment component 104 and/or replacement with another attachment component 104.

The cleaning assembly 100 may be selectively disassembled, in a “disassembled” state, in which the head component 102, the attachment component 104, and the handle component 106 are separated from one another, such as illustrated in FIG. 1. The disassembled state may be preferred for transportation, storage, or maintenance of the cleaning assembly 100.

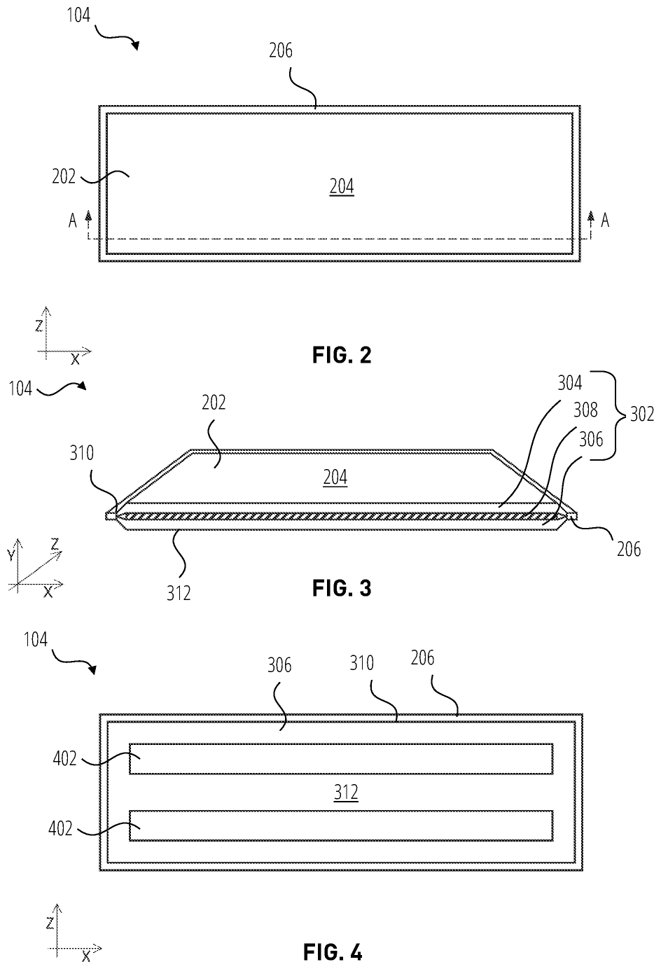

With reference to FIG. 2, the attachment component 104 may have, along at least a front surface 202 (configured as a cleaning surface 204), material(s) (e.g., relatively absorbent, soft, and flexible material(s)) suited for application against a surface to be cleaned (e.g., washed, dried). The material(s) of the cleaning surface 204 may be formed of and include one or more relatively-flexible, relatively-absorbent materials, such as terrycloth, chamois, microfiber, cotton cloth, and/or sponge.

In some embodiments, the material(s) of the attachment component 104 include multiple layers 302, as illustrated in FIG. 3, including a front layer 304 providing the cleaning surface 204 (and front surface 202), a rear layer 306 (providing a rear surface 312), and one or more internal layers (e.g., one or more inserts 308). The layers 302 may be joined together, along a periphery of the attachment component 104, by binding 206. The binding 206 may be joined to the layers 302 via one or more seams 310 (e.g., stitching). The binding 206 may be formed of and include a fabric. The seam 310 may attach the binding 206 directly to the front layer 304 and the rear layer 306 and, optionally, to the one or more inner layer(s) (e.g., insert 308).

In some embodiments, the front layer 304 and the rear layer 306 are both formed of a same material, such as a relatively soft, absorbent material (e.g., fabric), while the insert 308 may be formed of and include a material that is relatively more rigid than the front layer 304 and the rear layer 306. For example, the insert 308 may be formed of and include foam, polymer (e.g., plastic), wood, etc. In some embodiments, the insert 308 is formed of an interfacing fabric, which may be fused to one or more of the others of the layers 302, such as to one or both of the front layer 304 and/or the rear layer 306. Accordingly, the insert 308 may be configured to permit the attachment component 104 to substantially retain its generally planar shape while in use, including along the periphery of the attachment component 104, about the periphery of the insert(s) 308.

In other embodiments, the attachment component 104 is formed of substantially a single layer of absorbent, relatively-soft material providing both the cleaning surface 204 (front surface 202) and the rear surface 312 of the attachment component 104.

The material(s) of the attachment component 104 may be selected or otherwise configured to be machine washable and/or machine dryable to facilitate cleaning of the attachment component 104 between cycles of use.

With reference to FIG. 4, the attachment component 104 may include first fastener elements 402, in one or more segments (e.g., strips), on, in, or over the rear surface 312 of the attachment component 104. The first fastener elements 402 may be supported by (e.g., permanently or detachably attached to) the rear surface 312.

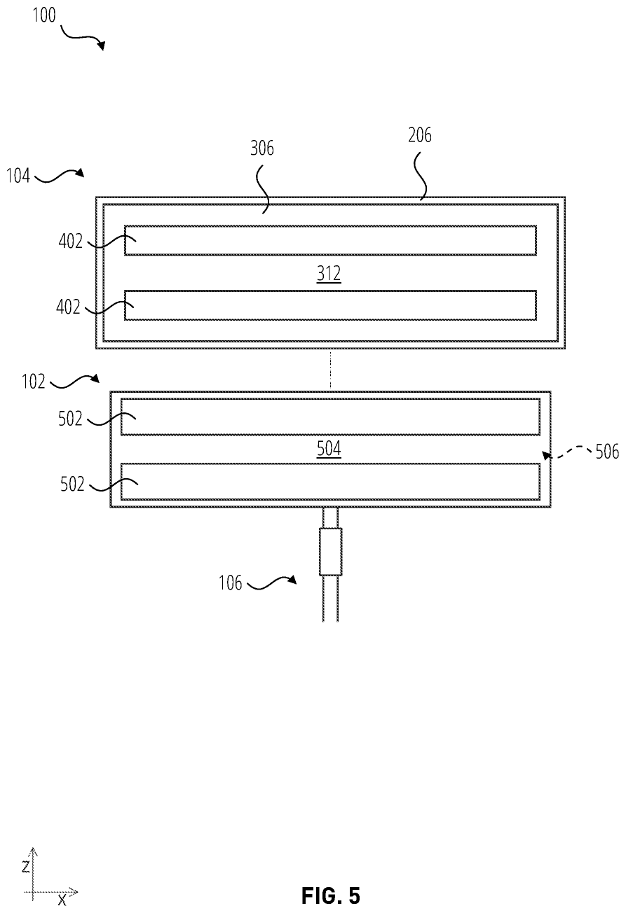

With reference to FIG. 5, the first fastener elements 402 of the attachment component 104 may be configured to engage with second fastener elements 502 of the head component 102. For example, first fastener element 402 may comprise a loop feature, and the second fastener elements 502 may comprise a hook feature, or vice versa, for a hook-and-loop engagement between the attachment component 104 and the head component 102. The first fastener elements 402 and the second fastener elements 502 may each be in the form of strips arranged near the periphery of the attachment component 104, such as elongate strips parallel with a length (e.g., X-axis dimension of FIG. 5) of the attachment component 104. In other embodiments, the first fastener elements 402 and/or second fastener elements 502 may be provided in a lesser or greater quantity of strips or other features. The first fastener elements 402 may have generally the same dimensions as the second fastener elements 502. In other embodiments, the first fastener elements 402 have somewhat different dimensions than the second fastener elements 502, such as illustrated in FIG. 5, wherein the second fastener elements 502 are of a generally greater surface area than the first fastener elements 402. In other embodiments, either or both the first fastener element 402 and/or the second fastener element 502 are configured to substantially extend (e.g., provide) a whole of the rear surface 312 or the front surface 504, respectively.

In other embodiments, the first fastener elements 402 and second fastener elements 502 include other engagement mechanisms, such as snaps, zippers, tape, magnets, and/or clips.

The first fastener elements 402 and the second fastener elements 502, which may be collectively referred to herein as the “fastener elements,” may be configured to facilitate the selective attachment and detachment between the attachment component 104 and the head component 102 and to retain the attachment component 104 on the head component 102 during use of the cleaning assembly 100 for cleaning (e.g., washing, drying) the surface of a structure (e.g., a recreational vehicle).

The second fastener elements 502 of the head component 102, for engaging with the first fastener elements 402 of the attachment component 104, may be wholly supported on the front surface 504 of the head component 102. A rear surface 506 of the head component 102 may be wholly free of elements for engaging the attachment component 104. Therefore, during use of the cleaning assembly 100 for, e.g., drying the sides of a recreation vehicle, the moisture absorbed by the cleaning surface 204 of the attachment component 104 may not be drawn toward the rear surface 506, which may lessen the likelihood of moisture dripping down upon the handle component 106 and/or the user during use of the cleaning assembly 100.

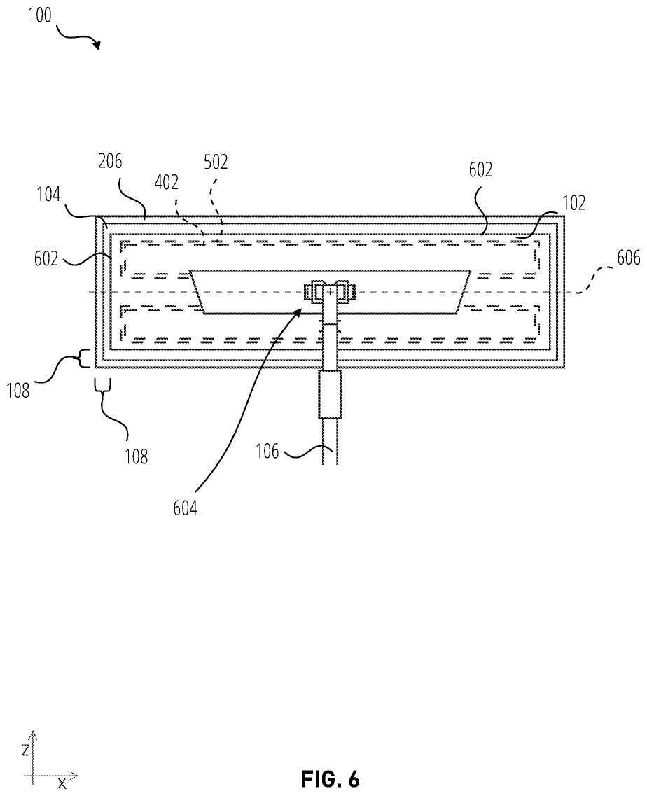

While FIG. 5 illustrates the attachment component 104 as detached from the other components of the cleaning assembly 100, FIG. 6 illustrates the attachment component 104 as attached to the head component 102 of the cleaning assembly 100 in a configuration usable for cleaning a surface of a structure. Though FIG. 6 illustrates a longitudinal centerline 606 of the head component 102 being oriented perpendicular to the handle component 106, this is not the only head-to-handle arrangement in which the head component 102 is in a configuration usable for cleaning, as described further below. To attach the attachment component 104 to the head component 102, the first fastener elements 402 may be substantially aligned with the second fastener elements 502 and the attachment component 104 manually pressed toward the head component 102, at least in embodiments in which the first fastener elements 402 and the second fastener elements 502 are pressure and/or force engaged (e.g., hook-and-loop attachments, tape attachments).

The cleaning surface 204 (FIG. 2 and FIG. 3) of the attachment component 104 may remain substantially wholly directed toward the surface being cleaned—while using the cleaning assembly 100 for cleaning—by virtue of, e.g., the relatively more rigid support of the insert 308 (in at least some embodiments) and the head component 102, in comparison to the general flexibility of the cleaning surface 204 (FIGS. 2 and 3) of the attachment component 104). The binding 206 may also provide some relative rigidity, compared to the material(s) of the cleaning surface 204 (FIG. 2) (e.g., front layer 304) and, in some embodiments, the rear surface 306 (FIG. 3) of the attachment component 104, to promote the attachment component 104 remaining in a substantially planar configuration during use.

The head component 102, to which the attachment component 104 is attached during use, may be formed of material(s) that is (are) relatively more rigid than the material(s) of the cleaning surface 204 and, in some embodiments, the other material(s) of the attachment component 104. Accordingly, the head component 102 may provide structural stability to the attachment component 104 during use for cleaning.

In some embodiments, the attachment component 104 is dimensioned to be generally wider and longer, and therefore of relatively greater surface area, than the head component 102. Accordingly, when the attachment component 104 is attached to the head component 102, the attachment component 104 may overhang 108 the edges 602 of the head component 102. The overhang 108 of the generally softer, more flexible material of the attachment component 104, relative to material(s) of the head component 102 may inhibit direct contact between the head component 102 and the surface being cleaned so as to mitigate (e.g., prevent) damage to (e.g., scratching of) the surface being cleaned. The overhang 108 areas, which may be in both the X-axis and Z-axis directions, as illustrated in FIG. 6, may provide additional cleaning contact area between the attachment component 104 and the surface being cleaned than if, for example, the attachment component 104 were dimensioned or attached to the head component 102 in such a way as to provide a cleaning surface area of about the same or lesser area than the area of the head component 102. The somewhat rigid insert 308 (FIG. 3) and binding 206 may also promote the attachment component 104 maintaining the overhang 108 areas extending beyond the edges 602 of the head component 102.

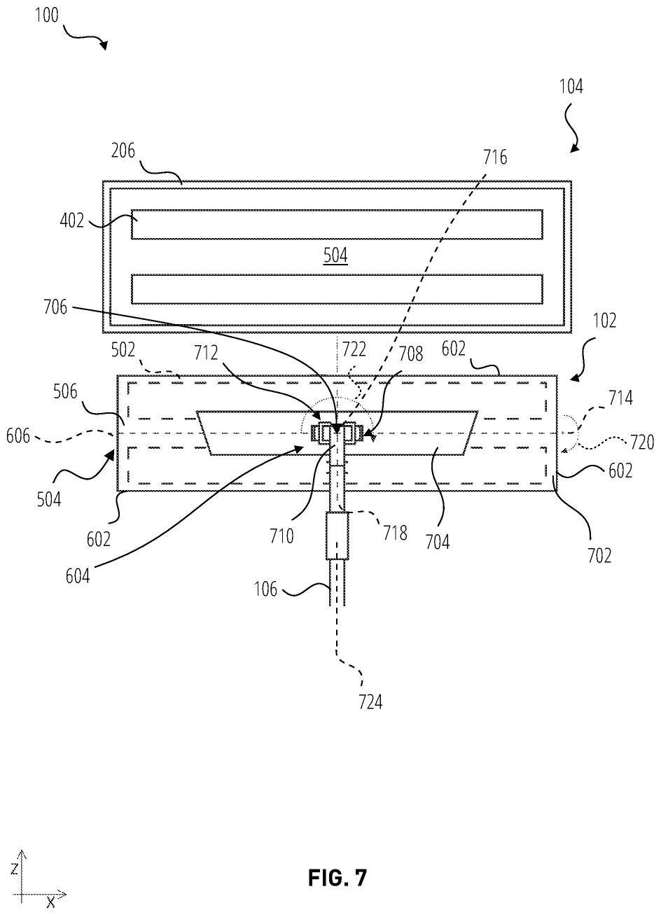

After use, the attachment component 104 may, again, be detached from the head component 102 of the cleaning assembly 100, as illustrated in FIG. 7, such as by pulling the attachment component 104 away from the head component 102 to disengage the first fastener elements 402 from the second fastener elements 502 (e.g., in embodiments in which the fastener elements are pressure-engaged, such as with hook-and-loop attachments, tape attachments, etc.). Accordingly, illustrated in FIG. 7 is a “partially-assembled” state of the cleaning assembly 100. A user may transition the cleaning assembly 100 to the partially-assembled state to allow for the attachment component 104 to be cleaned (e.g., laundered) independent of the other components of the cleaning assembly 100.

In some embodiments, the cleaning assembly 100 includes multiple individual attachment components 104. Each of the multiple attachment components 104 may be independently attachable to the attachment component 104 so that one attachment component 104 may be in use with the cleaning assembly 100 while one or more others of the attachment components 104 are being cleaned or stored for later use. The additional attachment components 104 may have the same materials and structures as one another, or may have different materials and/or structures as one another. For example, one attachment component 104 may have a chamois material as the cleaning surface 204, another attachment component 104 may have a terrycloth material as the cleaning surface 204, and another attachment component 104 may have a sponge material as the cleaning surface 204, or the like. As another example, one or more other attachment components 104 may have a relatively more abrasive, non-absorbent material as the cleaning surface 204 and be configured for scrubbing, while one or more other attachment components 104 may have a relatively less abrasive, absorbent material as the cleaning surface 204 and be configured for drying.

With continued reference to FIG. 7, the head component 102 may include a panel 702. The panel 702 may include a first surface (e.g., providing the rear surface 506 of the head component 102, such that the rear surface 506 of the head component 102 also defines the rear surface 506 of the panel 702) and an opposing second surface (e.g., providing, primarily, the front surface 504 of the head component 102, such that the front surface 504 of the head component 102 also primarily defines the front surface 504 of the panel 702). The rear surface 506 may be a flat or substantially flat (e.g., planar) surface.

In some embodiments, a mounting plate 704 is attached (e.g., affixed) to the rear surface 506 of the panel 702. In other embodiments, the mounting plate 704 is a defined area of, and integral with, the panel 702. The mounting plate 704 may be removably connected, permanently attached to, or integral with the rear surface 506 of the panel 702. In embodiments in which the mounting plate 704 is removably or non-removably attached to the panel 702, the mounting plate 704 may be attached, directly or indirectly, to the panel 702 by way of hardware interfaces (e.g., screws, latches), an adhesive connection (e.g., glue), a magnetic attachment, or any other known joining technique.

The panel 702 and the mounting plate 704 may be any suitable size and shape, and edges of the panel 702 may define the edges 602 of the head component 102. The mounting plate 704 may define a lesser surface area compared to an area of the rear surface 506 of the panel 702. The length (along the X-axis direction in FIG. 7) and the width (along the Z-axis direction in FIG. 7) of the mounting plate 704 may both be less than the width and length, respectively, of the panel 702. In some embodiments, such as illustrated in FIG. 7, the panel 702 exhibits a generally rectangular shape, and the mounting plate 704 exhibits a generally trapezoidal shape. In other embodiments either or both the panel 702 and the mounting plate 704 exhibit other geometrical shape(s), such as a rectangular shape, a trapezoidal shape, an elliptical shape, a circular shape, a square shape, a triangular shape, etc., or any combination of one or more of the foregoing shapes. The panel 702 and the mounting plate 704 may exhibit the same shapes, substantially the same shapes, or different shapes as one another. In some embodiments, the dimensions of the panel 702 are within a range from about 1 ft. (0.3 m) to about 5 ft. (1.5 m) for the length (i.e., X-axis direction of FIG. 7), such as about 2 ft. (0.6 m) to about 4 ft. (1.2 m) (e.g., about 3 ft. (0.9 m)) and within a range from about 4 in. (0.1 m) to about 24 in. (0.6 m) in for the length (i.e., Z-axis direction of FIG. 7), such as about 10 in. (0.3 m) to about 18 in. (0.5 m) (e.g., about 14 in. (0.4 m)). In some embodiments, the dimensions of the mounting plate 704 are within a range from about 6 in. (0.2 m) to about 4 ft. (1.2 m) for the length (i.e., in the X-axis direction of FIG. 7), such as about 1 ft. (0.3 m) to about 3 ft. (0.9 m) (e.g., about 2 ft. (0.6 m)) and within a range from about 2 in. (0.05 m) to about 12 in. (0.3 m) for the width (i.e., Z-axis direction of FIG. 7), such as about 5 in. (0.1 m) to about 9 in. (0.2 m) (e.g., about 7 in. (0.2 m)).

The mounting plate 704 may be centered or substantially centered on the rear surface 506 of the panel 702. The mounting plate 704 may be configured to provide additional rigidity to the panel 702. The additional rigidity may facilitate applying a substantially even pressure by the panel 702 on the attachment component 104, and by the attachment component 104 on the surface being cleaned, during use of the cleaning assembly 100.

The panel 702 and the mounting plate 704 may be formed of and include at least one relatively firm material, such as a substantially rigid material. For example, the panel 702 and/or the mounting plate 704 may be formed of and include one or more of at least one metal (e.g., stainless steel, titanium, aluminum, metal alloys, etc.), at least one glass (e.g., soda-lime, borosilicate, fiberglass, aluminosilicate, non-silicate, etc.), at least one ceramic (e.g., quartz, aluminum oxide, clay, porcelain, etc.), at least one polymer (e.g., amber, wool, silk, natural rubber, cellulose, polyethylene, polypropylene, polystyrene, polyvinyl chloride, synthetic rubber, phenol formaldehyde resin (or Bakelite), neoprene, nylon, polyacrylonitrile, PVB, silicone, etc.), and at least one composite (e.g., metal matrix composites, ceramic matrix composites, reinforced plastics (e.g., fiberglass), composite wood, etc.). The panel 702 and the mounting plate 704 may have substantially the same material composition as one another, or they may have different material compositions than one another. In some embodiments, the panel 702 is formed of material(s) that exhibit relatively greater flexibility than material(s) of the mounting plate 704. In other embodiments, both the panel 702 and the mounting plate 704 have substantially the same rigidity (e.g., substantially non-flexible) as one another.

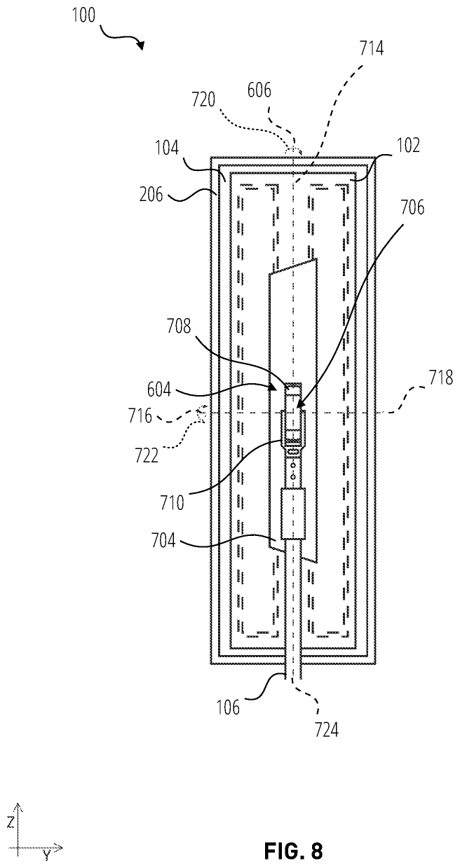

With continued reference to FIG. 7 and with reference to FIG. 8, the cleaning assembly 100 may further include a joint sub-assembly 604 configured to connect the handle component 106 to the head component 102 while facilitating at least some range of relative motion (e.g., rotation, pivoting). The joint sub-assembly 604 may, therefore, define a pivot point 706, i.e., a point about which the attachment component 104 may be moved relative to the head component 102. In some embodiments, such as described below, the joint sub-assembly 604 is configured to permit rotational motion so that the cleaning assembly 100 may be selectively transitioned between a “horizontal configuration” (FIG. 7) and a “vertical configuration” (FIG. 8). In the horizontal configuration (FIG. 7), the longitudinal centerline 606 of the head component 102 is substantially perpendicular to a longitudinal centerline 724 of the handle component 106. In the vertical configuration (FIG. 8), the longitudinal centerline 606 of the head component 102 is substantially parallel to the longitudinal centerline 724 of the handle component 106.

The joint sub-assembly 604 may include a first portion 708 pivotally and/or rotationally connected to the second portion 710. The first portion 708 may be attached or attachable to the head component 102 with a substantially fixed orientation between the first portion 708 and the head component 102. Accordingly, descriptions herein as to the relative position of the first portion 708 may equally apply to the relative position of the head component 102 (and the attachment component 104, when attached). The second portion 710 may be attached or attachable to the handle component 106 with a substantially fixed orientation between the second portion 710 and the handle component 106. Accordingly, descriptions herein as to the relative position of the second portion 710 may equally apply to the relative position of the handle component 106.

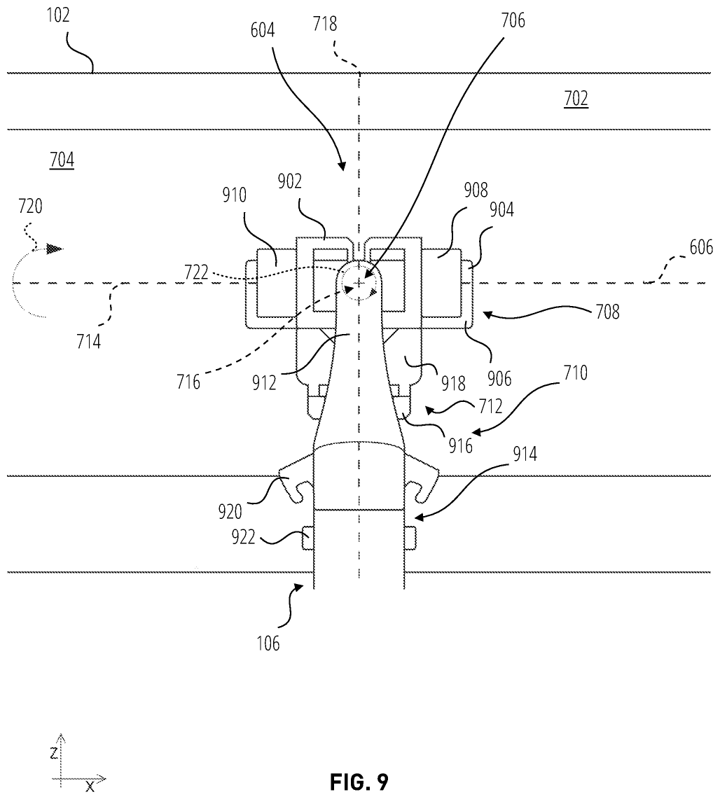

In some embodiments, the joint sub-assembly 604 further includes a rotating member (discussed further below in reference to FIG. 9) and a locking mechanism 712 that are configured to connect the first portion 708 to the second portion 710 and to permit selective rotation about two substantially perpendicular rotation axes, e.g., a first axis 714 (extending in parallel with the X-axis direction in the horizontal configuration shown in FIG. 7, and extending in parallel with the Z-axis direction in the vertical configuration shown in FIG. 8) and a second axis 716 (extending in parallel with the Y-axis direction, perpendicular to the X-Z plane in the horizontal configuration shown in FIG. 7, and extending in parallel with the Y-axis direction in the vertical configuration shown in FIG. 8). The first axis 714 may be defined in a fixed, parallel relationship to the longitudinal centerline 606 of the head component 102. The second axis 716 may be defined in a fixed, parallel relationship to the front-to-back lateral centerline of the handle component 106.

In at least some embodiments, the locking mechanism 712 is configured to be selectively engaged or disengaged when the cleaning assembly 100 is in the horizontal configuration (FIG. 7). When engaged, the locking mechanism 712 may limit rotation about only the first axis 714 (e.g., in first rotational direction 720, or the reverse thereof). When disengaged, the locking mechanism 712 may further permit rotation about the second axis 716 (e.g., in second rotational direction 722, or the reverse thereof). The locking mechanism 712 may also be configured so that, when disengaged, the cleaning assembly 100 may be transitioned to the vertical configuration (FIG. 8), as described further below.

In the horizontal configuration (FIG. 7) and in the vertical configuration (FIG. 8), the head component 102 may be rotated about the first axis 714, e.g., tilted forward and rearward along the first rotational direction 720 or its reverse (e.g., top tilted into the page of and out of the page, respectively, of the illustration). With the locking mechanism 712 engaged in the horizontal configuration (FIG. 7), the head component 102 may not be readily swiveled out of the horizontal orientation (in second rotational direction 722 or its reverse, about the second axis 716). Therefore, as a user washes a target surface (e.g., a side of a recreational vehicle), the cleaning surface 204 of the attachment component 104 may be maintained substantially flat against the target surface as the user moves the cleaning assembly 100 upwards and downwards against the target surface, while also maintaining control of the orientation of the head component 102. In the horizontal configuration (FIG. 7) with the locking mechanism 712 selectively disengaged, the head component 102 may also be free to rotate about the second axis 716 (e.g., back and/or forth through second rotational direction 722), facilitating pivoting through the X-Z plane.

With continued reference to FIG. 7 and FIG. 8, the first portion 708 of the joint sub-assembly 604 may be supported by the mounting plate 704 of the head component 102, such as by being attached or attachable, directly or indirectly, selectively or permanently, to the mounting plate 704, e.g., by hardware interfaces, an adhesive connection (e.g., glue). In some embodiments, the first portion 708 may be integral with the mounting plate 704.

The second portion 710 of the joint sub-assembly 604 may be attached or attachable, directly or indirectly, selectively or permanently, to the handle component 106. In some embodiments, as described further below, the second portion 710 may be configured to accommodate selective attachment and detachment of the handle component 106.

The cleaning assembly 100 may be transitioned from the horizontal configuration (FIG. 7) (wherein the head component 102 is generally in the X-Z plane and the rear of the handle component 106 faces out of the illustrated page) to the vertical configuration (FIG. 8) (wherein the head component 102 is generally in the Y-Z plane and the right side of the handle component 106 faces out of the illustrated page). To transition from the horizontal configuration (FIG. 7) to the vertical configuration (FIG. 8)—while keeping the handle component 106 vertical (for point of reference)—the first portion 708 of the joint sub-assembly 604 may be rotated about the first axis 714 (in reverse direction of the illustrated arrow of first rotational direction 720) until the head component 102 (and its mounting plate 704) is substantially parallel to the X-Y plane and substantially perpendicular to the longitudinal centerline 724 of the handle component 106. In this position, a lateral centerline 718 of the head component 102 is substantially parallel to the Y-axis in the X-Y plane and is substantially parallel to the second axis 716. Then, the first portion 708 of the joint sub-assembly 604 may be rotated about the second axis 716 (in the second rotational direction 722) to bring one shorter side of the mounting plate 704 downward toward the handle component 106 with the other shorter side of the mounting plate 704 directed upward, as illustrated in FIG. 8.

In some embodiments, such as that illustrated in FIG. 7, the joint sub-assembly 604 is disposed at a position along the mounting plate 704 (and the head component 102) such that the pivot point 706 aligns (e.g., in the Y-axis direction) with an intersection of the longitudinal centerline 606 and the lateral centerline 718 of the head component 102. Therefore, the first axis 714 substantially aligns (e.g., in the X-Y plane) with, and is parallel to, the longitudinal centerline 606 of the head component 102, and the second axis 716 is positioned along the lateral centerline 718 of the head component 102.

In other embodiments, the joint sub-assembly 604 is disposed elsewhere along the surface of the mounting plate 704 (and the head component 102), such as offset (e.g., in the Z-axis direction) from the longitudinal centerline 606 and/or offset (e.g., in the X-axis direction) from the lateral centerline 718.

By rotating the second portion 710 of the joint sub-assembly 604 about the first axis 714 (to and/or fro in the first rotational direction 720), when in the cleaning assembly 100 is in the horizontal configuration (FIG. 7), and by rotating the second portion 710 about the second axis 716 (to and/or fro in the second rotational direction 722) when the cleaning assembly 100 is in the vertical configuration (FIG. 8), the head component 102 (and attachment component 104) may be tilted, relative to the handle component 106, through about 180 degrees so as to invert the head component 102 (e.g., without inverting the handle component 106). For example, with regard to the horizontal configuration (FIG. 7), the head component 102 may be tilted about the first axis 714 (in a reverse direction of the arrow of first rotational direction 720) from the position illustrated in FIG. 7—wherein the rear surface 506 of the head component 102 faces toward the user (and the lowest illustrated edge 602 is below the pivot point 706)—to a position such as that illustrated in FIG. 5—wherein the front surface 504 of the head component 102 faces toward the user (and the same edge 602 is now the highest illustrated edge and is above the pivot point 706), inverting the head component 102 lengthwise. Likewise, with regard to the vertical configuration (FIG. 8), the head component 102 may be selectively inverted by the user by tilting the head component 102 about the second axis 716 (in a reverse direction of the arrow of second rotational direction 722), inverting the head component 102 widthwise. Therefore, the user may selectively invert the head component 102 so that a different portion of the cleaning surface 204 (FIG. 2) is upward. After inverting, the user may turn the handle component 106 around the longitudinal axis 724 of the handle component 106 (e.g., through the X-Y plane) to re-direct the cleaning surface 204 (FIG. 2) toward the target surface for continued cleaning.

Though FIG. 7 and FIG. 8 illustrate two particular configurations (e.g., the horizontal configuration (FIG. 7) and the vertical configuration (FIG. 8)) that are generally perpendicular to one another, the disclosure is not so limited. In other embodiments, the joint sub-assembly 604 may be configured to enable more configurations, such as angled configurations.

In some embodiments, the joint sub-assembly 604 may be configured to permit relatively free or selectively lockable pivoting of the second portion 710 about the pivot point 706.

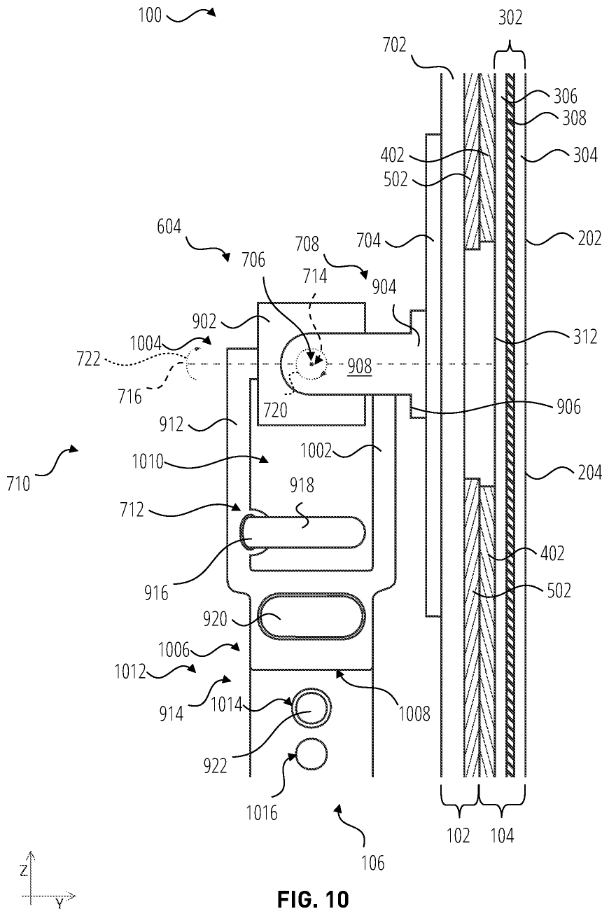

With reference to FIG. 9 and FIG. 10, provided is an enlarged, more detailed illustration of the joint sub-assembly 604 that may be included in embodiments of the cleaning assembly, wherein the joint sub-assembly 604 and its locking mechanism 712 are configured to enable selective transitioning of the cleaning assembly 100 between the horizontal configuration (FIG. 7) and the vertical configuration (FIG. 8) and to substantially lock the head component 102 into its horizontal (FIG. 7) or vertical (FIG. 8) orientation, relative to the handle component 106, when the cleaning assembly 100 is in the horizontal configuration (FIG. 7) or the vertical orientation (FIG. 8), respectively. FIG. 9 and FIG. 10 illustrate a distal end 914 of the handle component 106 selectively attached to the joint sub-assembly 604.

The first portion 708 of the joint sub-assembly 604 may include a base 904, which may be rotatably attached to a rotating member 902. The base 904 may have a flat surface 906 that is supported by (e.g., affixed to) or, in some embodiments, integral with the mounting plate 704. A first arm 908 and a second arm 910 may extend from the flat surface 906 of the base 904, e.g., substantially perpendicularly (e.g., normal) to the plane of the mounting plate 704. The first arm 908 and the second arm 910—of the first portion 708 of the joint sub-assembly 604—may be positioned at opposite sides of the flat surface 906 of the base 904 from one another.

The rotating member 902 may be supported laterally between and by the first arm 908 and the second arm 910 of the first portion 708. In the horizontal configuration (FIG. 7 and FIG. 9), the rotating member 902 may be substantially free to rotate about the first axis 714 (e.g., to or fro in rotational direction 720), relative to the first arm 908 and the second arm 910, whether or not the locking mechanism 712 is engaged. Accordingly, the rotating member 902, first arm 908, and second arm 910 may effectively define the first axis 714 of rotation in a fixed relation to the mounting plate 704, the panel 702, and therefore also to the longitudinal centerline 606 of the head component 102.

The length (e.g., dimension in the Y-axis direction of FIG. 9 and FIG. 10) of each of the first arm 908 and the second arm 910 may be tailored to be substantially equal to one another so that the first axis 714 of rotation is substantially parallel to the longitudinal centerline 606 of the head component 102. In some embodiments, each of the first arm 908 and the second arm 910 has a length within a range from about 1 in. (2.5 cm) to about 2 in. (5 cm).

With reference to the side-view illustration of FIG. 10, the length (e.g., Y-axis dimension) of each of the first arm 908 and the second arm 910 and the dimensions of the rotating member 902 may also be tailored to position the rotating member 902 at a sufficient distance (e.g., along the Y-axis) from the flat surface 906 of the base 904 so that, as the rotating member 902 rotates (e.g., to or fro in first rotational direction 720) about the first axis 714 (which extends through the pivot point 706 in the X-axis direction of FIG. 10), there is no interference (e.g., physical contact) between the rotating member 902 and the flat surface 906. Rotation of the rotating member 902 about the first axis 714 may, therefore, be substantially uninhibited through about 180 degrees of motion when the cleaning assembly 100 is in the horizontal configuration (FIG. 7, FIG. 9, FIG. 10). That is, the range of motion of the rotating member 902 (and therefore the handle component 106) relative to the flat surface 906 (and therefore also the mounting plate 704, the panel 702, and the head component 102) may be from about 0 degrees to about 180 degrees about the first axis 714 (FIG. 9) through the Y-Z plane. Therefore, as discussed above, the head component 102 may be substantially inverted about the first axis 714 (FIG. 9) (e.g., to or fro in first rotational direction 720) while the cleaning assembly 100 is in the horizontal configuration (FIG. 7, FIG. 9, FIG. 10).

With continued reference to FIG. 9 and FIG. 10, the second portion 710 of the joint sub-assembly 604 extends from the rotating member 902 and may include the locking mechanism 712 configured to selectively limit the rotation of the second portion 710, relative to the first portion 708. With particular reference to FIG. 10, the second portion 710 may—like the first portion—include a first arm 912 and a second arm 1002 extending from the rotating member 902. The rotating member 902 may be positioned longitudinally (Y-axis direction) between the first arm 912 and the second arm 1002 of the second portion 710 of the joint sub-assembly. Correspondingly and as illustrated in FIG. 9, the rotating member 902 may be positioned laterally (X-axis direction) between the first arm 908 and the second arm 910 of the first portion 708 of the joint sub-assembly 604. The rotating member 902 may be configured to permit rotatable movement—about the second axis 716, to or fro in second rotational direction 722—of the first arm 912 and the second arm 1002 of the second portion 710, at least when the locking mechanism 712 is disengaged. Thus, the first arm 912 and the second arm 1002 of the second portion 710 of the joint sub-assembly 604 define the second axis 716 (extending in the Y-axis direction).

The first arm 912 and the second arm 1002 of the second portion 710 of the joint sub-assembly 604 extend from a first end 1004 of the second portion 710 to a second end 1006 of the second portion 710. The second end 1006 of the second portion 710 may define a first opening 1008 of a dimension (e.g., circumference and depth) configured to receive the distal end 914 of the handle component 106. Accordingly, the first arm 912 and the second arm 1002 of the second portion 710 of the joint sub-assembly 604 may be in a fixed relation to the handle component 106 once attached, such that the second axis 716 may be in a fixed parallel relation to the front-to-back transverse centerline (along the Y-axis) of the handle component 106.

In some embodiments, the locking mechanism 712 of the joint sub-assembly 604 includes a shaft 916, which may be housed in the first arm 912 of the second portion 710 and configured so that the shaft 916 may rotate within the first arm 912 about the X-axis (perpendicular to the Y-Z plane of FIG. 10). A stopper 918 extends from, and may be affixed to, the shaft 916 in a perpendicular direction. The stopper 918 may be dimensioned and otherwise tailored so that when the stopper 918 is turned (via rotation of the shaft 916) toward the first end 1004 of the second portion 710, an edge of the stopper 918 comes to abut the rotating member 902 along a lower surface of the rotating member 902, as illustrated in FIG. 9. In this position the locking mechanism 712 is “engaged,” and the second portion 710 of the joint sub-assembly 604 is inhibited from rotating about the second axis 716 due to the interference between the rotating member 902 and the stopper 918 of the locking mechanism 712. While the locking mechanism 712 is engaged, the second portion 710 (and rotating member 902) may still be free to rotate about the first axis 714 (e.g., to and fro of first rotational direction 720).

The locking mechanism 712 may be selectively transitioned from being “engaged” (FIG. 9) to being “disengaged” (FIG. 10) by rotating the stopper 918 away from the rotating member 902. As disengaged, there is no mechanical interference inhibiting the second portion 710 of the joint sub-assembly 604 from rotating about the second axis 716. Therefore, when the locking mechanism 712 is disengaged, the second portion 710 may be free to rotate, relative to the first portion 708, about both the second axis 716 (to and fro in second rotational direction 722) and the first axis 714 (to and fro in first rotational direction 720).

With the locking mechanism 712 in the disengaged state (FIG. 10), an opening 1010 is defined between the first arm 912 and the second arm 1002 of the second portion 710 of the joint sub-assembly 604. With the locking mechanism 712 disengaged, the cleaning assembly 100 may be transitioned from the horizontal configuration (FIG. 10, FIG. 9, and FIG. 7) to the vertical configuration (FIG. 8). To do so, the second portion 710 may be rotated, relative to the first portion 708, about the first axis 714 (in first rotational direction 720) until the second portion 710 is substantially perpendicular to the flat surface 906 of the base 904. With the locking mechanism 712 still disengaged, the second portion 710 may then be rotated about the second axis 716, which will then be in the X-axis direction of FIG. 10. The rotation may be continued until, at a maximum, one of the first arm 908 and the second arm 910 of the first portion 708 is received in the opening 1010 between the first arm 912 and the second arm 1002 of the second portion 710. At this position, the cleaning assembly 100 is in the vertical configuration (FIG. 8) and the first portion 708 is substantially free to rotate about the second axis 716 to tilt the head component 102 back and forth (e.g., to and fro in second rotational direction 722 of FIG. 8). The rotating member 902 (and the second portion 710) may be inhibited from substantially rotating about the first axis 714 due to mechanical interference between the second portion 710 (e.g., the first arm 912 and the second arm 1002 of the second portion 710) and whichever of the first arm 908 and the second arm 910 of the first portion 708 is received within the opening 1010. Once the second portion 710 has been rotated about the second axis 716 a sufficient amount so as to remove the first arm 908 or second arm 910 of the first portion 708 from the opening 1010 between the first arm 912 and the second arm 1002 of the second portion 710, rotation of the second portion 710 about the first axis 714 may once again be facilitated.

Accordingly, the rotating member 902 and locking mechanism 712 of the joint sub-assembly 604 may be configured to permit selective, controlled rotation of the head component 102 (and the attachment component 104) relative to the handle component 106 about at least two perpendicular axes, which may provide the user with control over the orientation of the head component 102 during use of the cleaning assembly 100.

With continued reference to FIG. 10, the second portion 710 of the joint sub-assembly 604 may be configured to selectively receive the distal end 914 of the handle component 106 so as to selectively attach the handle component 106 to the head component 102 of the cleaning assembly 100. The second end 1006 of the second portion 710 may define a first opening 1008 of a dimension (e.g., circumference and depth) configured to receive the distal end 914 of the handle component 106.

The second portion 710 may include connection features 1012 to facilitate the selective attachment and detachment of the handle component 106. In some embodiments, the connection features 1012 include a threaded (e.g., screw) connection, a tongue-and-groove connection, a latch connection, a button-and-pin connection, another male-end to female-end connection mechanism, or the like, as known in the art. For example, in some embodiments, the connection feature 1012 includes a button 920 (e.g., a mechanically depressible button) operatively connected to at least one pin 922. The button 920 may be housed in the second portion 710 of the joint sub-assembly 604, proximate the second end 1006. The pin 922 may be configured so that, when the distal end 914 of the handle component 106 is received within the first opening 1008, each pin 922 engages with a respective second opening 1014 defined in the distal end 914 of the handle component 106. The pin 922 and button 920 may be configured, by known techniques, so that, when the button 920 is not being pressed, the pin 922 may be spring biased radially outward, through the second opening 1014, providing a mechanical interference inhibiting the handle component 106 from sliding out from the first opening 1008. Correspondingly, when the button 920 is pressed (e.g., compressed into the second portion 710 of the joint sub-assembly 604), the pin 922 may be retracted away from (e.g., drawn out from) the second opening 1014, thereby removing the mechanical interference and enabling the distal end 914 of the handle component 106 to be slid out from the first opening 1008, detaching the handle component 106 from the joint sub-assembly 604.

In some embodiments, there are multiple pins 922 operatively connected to one or more buttons 920, and additional openings 1016 in the distal end 914 of the handle component 106 to engage with the additional pins 922.

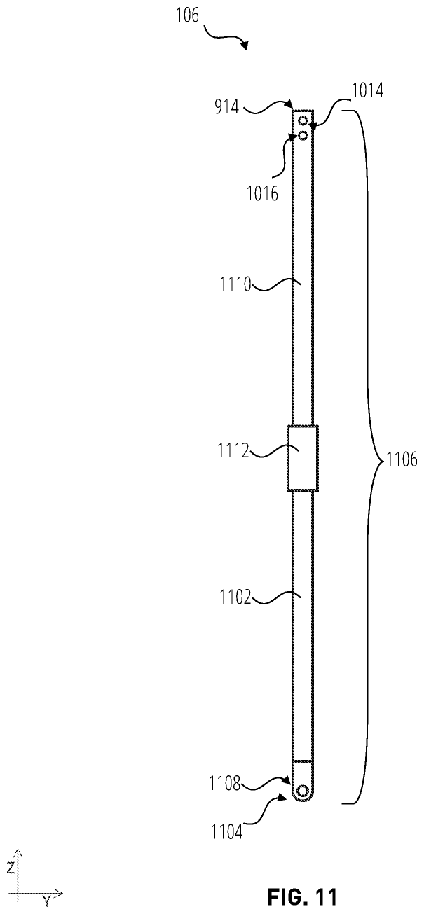

Referring to FIG. 11, the handle component 106 may include a proximal end 1104 opposite the distal end 914. A shaft 1106 may extend from the proximal end 1104 to the distal end 914. The distal end 914 of the handle component 106 may be configured for selective engagement with the second end 1006 (FIG. 10) of the second portion 710 (FIG. 10) of the joint sub-assembly 604 (FIG. 10), as described above.

In some embodiments, the proximal end 1104 defines an opening 1108 for receiving a hook or other attachment to facilitate hanging (e.g., inverted) storage of the cleaning assembly 100 when not in use. In other embodiments, the proximal end 1104 includes a hook, a cord, or other storage feature.

The shaft 1106 may include one or more portions, such as a first portion 1110 and a second portion 1102, which may be substantially hollow and substantially cylindrically shaped with a substantially circular transverse cross-sectional area. In other embodiments, the shaft 1106 and portions (e.g., first portion 1110, second portion 1102) thereof may exhibit a different transverse cross-sectional shape (e.g., square, otherwise rectangular, otherwise round).

In embodiments in which the shaft 1106 includes multiple portions (e.g., first portion 1110, second portion 1102), portions relatively nearer to the distal end 914 of the handle component 106 may be relatively narrower, in diameter, than portions relatively nearer to the proximal end 1104 of the handle component 106, or vice versa. The diameters of respective portions may be tailored to narrow, from the proximal end 1104 to the distal end 914 of the shaft 1106, so that a proximally neighboring portion may be received within the interior of its distally neighboring portion, or vice versa. For example, the first portion 1110 of FIG. 11 may be narrower in diameter than the second portion 1102, and the first portion 1110 may be wholly or partially received within (e.g., slideably inserted into) the interior of the second portion 1102. Accordingly, the portions (e.g., first portion 708, second portion 710) may permit the shaft 1106 to be telescoping with a selectively extendable length (e.g., Z-axis dimension). When in an extended state, the shaft 1106 may facilitate cleaning of portions of the target surface that may otherwise be out of reach (e.g., out of arms' reach). When in a non-extended state, the shaft 1106 may facilitate cleaning of portions of the target surface that are nearer to ground level.

The handle component 106 may also include a grip 1112 along the shaft 1106. The grip 1112 may be configured to secure the first portion 1110 relative to the second portion 1102 so that the user may select and secure the shaft 1106 at substantially any length from a minimum telescoped length to a maximum telescoped length. In some embodiments, the lengths of the shaft 1106 and the portions thereof may be tailored so that the shaft 1106 may be extended to any length within a range from about 4 ft. (1.2 m) to about 8 ft. (2.4 m).

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated. Further, embodiments of the disclosure have utility with different and various devices and materials.

1. A cleaning assembly, comprising:
a head component including a panel;
an attachment component removably attachable to a front surface of the panel;
a joint sub-assembly supported by a rear surface of the panel; and
a handle component selectively attachable to the joint sub-assembly,
wherein the joint sub-assembly defines at least two axes of rotation for moving the head component relative to the handle component, the at least two axes of rotation comprising a first axis and a second axis that is perpendicular to the first axis.

2. The cleaning assembly of claim 1, further comprising a mounting plate attached to the rear surface of the panel, wherein the joint sub-assembly is attached to the mounting plate.

3. The cleaning assembly of claim 1, wherein the attachment component is substantially planar when attached to the front surface of the panel.

4. The cleaning assembly of claim 1, wherein the attachment component extends beyond a periphery of the panel when attached to the front surface of the panel.

5. The cleaning assembly of claim 1, wherein the attachment component comprises:
a rear layer;
a front layer; and
at least one other layer between the rear layer and the front layer,
the at least one other layer exhibiting relatively greater rigidity than material of the front layer.

6. The cleaning assembly of claim 5, wherein the at least one other layer comprises a layer of interfacing fabric.

7. The cleaning assembly of claim 5, further comprising binding along a periphery of the attachment component, the at least one other layer being enclosed between the rear layer and the front layer by the binding.

8. The cleaning assembly of claim 1, wherein the attachment component comprises a cleaning surface comprising an absorbent material.

9. The cleaning assembly of claim 8, wherein the absorbent material comprises one or more of terrycloth, chamois, microfiber, and cotton cloth.

10. The cleaning assembly of claim 1, wherein:
the attachment component comprises at least one first fastener element; and
the head component comprises at least one second fastener element configured to selectively attach to the at least one first fastener element.

11. The cleaning assembly of claim 10, wherein the at least one first fastener element and the at least one second fastener element comprise hook-and-loop fastener elements.

12. The cleaning assembly of claim 1, wherein the joint sub-assembly comprises:
a first portion supported in fixed relation by the head component, the first portion defining the first axis;
a second portion attachable in fixed relation to the handle component defining the second axis; and
a rotating member rotationally connecting the first portion to the second portion.

13. The cleaning assembly of claim 12, wherein the joint sub-assembly further comprises a locking mechanism configured to selectively inhibit rotation of the first portion relative to the second portion about the second axis when the locking mechanism is engaged and the cleaning assembly is in a horizontal configuration in which the handle component is parallel to a lateral centerline of the head component.

14. The cleaning assembly of claim 13, wherein the locking mechanism is configured not to inhibit rotation of the first portion relative to the second portion about the first axis when the locking mechanism is engaged and the cleaning assembly is in the horizontal configuration.

15. The cleaning assembly of claim 1, wherein the handle component comprises a selectively extendable shaft comprising at least two portions.

16. A method for using the cleaning assembly of claim 1 to clean a target surface of a vehicle, the method comprising:
removably attaching the attachment component to the front surface of the panel of the head component;
removably attaching the handle component to the joint sub-assembly;
applying a cleaning surface of the attachment component against a target surface of a vehicle, the target surface being substantially planar and substantially vertical; and
manipulating the handle component to move the head component along the target surface while maintaining direct contact between the target surface and substantially a whole of the cleaning surface of the attachment component.

17. The method of claim 16, further comprising:
removing the attachment component from the front surface of the panel of the head component; and
attaching another attachment component to the front surface of the panel of the head component.

18. The method of claim 16, wherein the method does not comprise overlapping the attachment component to any portion of the rear surface of the panel of the head component.

19. The method of claim 16, further comprising engaging a locking mechanism of the joint sub-assembly to inhibit rotation of the head component relative to the handle component about the second axis.

20. The method of claim 16, further comprising extending a length of the handle component, comprising telescoping a first portion of a shaft of the handle component from a second portion of the shaft of the handle component.
